(19) United States
(12) Patent Application Publication
(10) Pub. No.: US 2026/0273471 A1
(43) Pub. Date: Sep. 17, 2026

(54) CLEANING METHOD OF MEMBRANE HOUSING, MEMBRANE HOUSING CLEANED BY THE CLEANING METHOD, AND ULTRAPURE WATER MANUFACTURING APPARATUS INCLUDING THE MEMBRANE HOUSING

(71) Applicant: ORGANO CORPORATION, Tokyo (JP)

(72) Inventors: Ayumi TEZUKA, Tokyo (JP); Kyohei TSUTANO, Tokyo (JP)

(73) Assignee: ORGANO CORPORATION, Tokyo (JP)

(21) Appl. No.: 19/471,470

(22) PCT Filed: Feb. 26, 2024
(86) PCT No.: PCT/JP2024/006852

§ 371 Date: Oct. 1, 2025

(30) Foreign Application Priority Data
Apr. 4, 2023 (JP) 2023-060870

(51) Int. Cl. B01D 65/02; C02F 1/42; C02F 1/44; C02F 103/04

(52) U.S. Cl. CPC B01D 65/027; C02F 1/42; C02F 1/44; B01D 2321/162; B01D 2321/40; C02F 2103/04; C02F 2303/14

(57) ABSTRACT

A method for cleaning a membrane housing includes: a first cleaning introducing a cleaning solution having a metal concentration into the housing, the housing interior thereby contacting the solution; a second cleaning, performed after completion of the first cleaning, of passing ultrapure water through the housing, the housing interior thereby contacting the ultrapure water; an analysis, performed during or after the second cleaning, of analyzing the metal concentration in the ultrapure water contacting the housing interior and has been discharged from the housing during the second cleaning, or analyzing the metal concentration in the ultrapure water contacting the housing interior and has been discharged from the housing after the second cleaning, by passing ultrapure water through the housing again; and determining, based on the results of the analysis, whether it is necessary to perform the second cleaning again, or to perform both the first and the second cleaning again.

### TECHNICAL FIELD

The present invention relates to a method for cleaning a membrane housing used in the production of ultrapure water and the like, a membrane housing cleaned by the cleaning method, and an ultrapure water production apparatus equipped with the membrane housing.

### BACKGROUND ART

Ultrapure water is generally produced by sequentially treating raw water (river water, groundwater, industrial water, and the like) through a pretreatment system, a primary pure water system, and a secondary pure water system (subsystem).

Ultrapure water is used in a variety of situations, including trace analysis and the semiconductor manufacturing process. For example, ultrapure water is used for various applications such as blank testing, sample dilution, and preparation of reference materials at research institutes, as well as for the cleaning step in the semiconductor manufacturing process.

Since metals in ultrapure water directly cause blank contamination in experimental values and reduce semiconductor device yields, ultrapure water with even higher purity is required.

For example, Patent Literature 1 discloses that impurities (especially metals) contained in the water-flow column 1 can be removed during the regeneration process by passing an aqueous solution of an acid such as hydrochloric acid through the ion exchanger.

Patent Literature 2 discloses that when an acid, e.g., hydrochloric acid, nitric acid, or another inorganic strong acid, is added to ultrapure water at a concentration in the range of 1 mg/L to 100 mg/L, and then the ultrapure water is passed through the separation membrane module, metal ions are desorbed and released from the polymer having ion exchange groups that adsorb residual metals on the primary side of the separation membrane, and thus the polymer having ion exchange groups is regenerated.

### CITATION LIST

### Patent Literature

Patent Literature 1: JP 2021-53547 A
Patent Literature 2: JP 2018-34157 A

### SUMMARY OF THE INVENTION

### Technical Problem

With the rapid increase in integration and miniaturization of semiconductor devices in recent years, control standards for the concentration of metallic impurities in ultrapure water have become increasingly strict. Accordingly, ultrapure water with purity higher than that used for analysis at research institutions and the like is needed.

For example, in an inductively coupled plasma mass spectrometer (ICP-MS), which is used to analyze trace metals, it is essential to reduce the metal content (background) in ultrapure water used as a blank in order to analyze lower concentrations. To obtain high-purity ultrapure water, an ion exchanger, a microfiltration membrane (MF), or an ultrafiltration membrane (UF) may be installed between the ultrapure water production facility and the point of use (e.g., cleaning equipment), or near the cleaning equipment, to further reduce impurities such as metal ions and fine particles in the ultrapure water. However, if a membrane housing is installed with insufficient conditioning (cleaning condition), impurities may leach from the membrane housing and degrade the quality of the ultrapure water supplied to the point of use.

In addition, leaching of impurities from the membrane housing can be reduced by continuously flowing ultrapure water through the membrane housing; however, it requires a considerable amount of time.

Therefore, it is an object of the present invention to provide a method for cleaning a membrane housing that further reduces the leaching of trace amounts of impurities.

### Solution to Problem

The object of this invention is achieved by
a method for cleaning a membrane housing having an inlet for introducing a liquid to be treated and an outlet for discharging the treated liquid, wherein the liquid to be treated introduced from the inlet is treated and the treated liquid is discharged from the outlet,
the method comprising:
a first cleaning step of introducing a cleaning solution having a metal concentration (concentration of each element) of 100 ng/L or less into the membrane housing, thereby bringing the interior of the membrane housing into contact with the cleaning solution;
a second cleaning step, performed after completion of the first cleaning step, of passing ultrapure water through the membrane housing, thereby bringing the interior of the membrane housing into contact with the ultrapure water;
an analysis step, performed during or after completion of the second cleaning step, of
analyzing the metal concentration in the ultrapure water that has come into contact with the interior of the membrane housing and has been discharged from the membrane housing during the second cleaning step, or
analyzing the metal concentration in the ultrapure water that has come into contact with the interior of the membrane housing and has been discharged from the membrane housing after completion of the second cleaning step, by passing ultrapure water through the membrane housing again; and
a step of determining, based on the results obtained in the analysis step, whether it is necessary to perform the second cleaning step again, or to perform both the first cleaning step and the second cleaning step again.

### Effects of the Invention

According to the present invention, there is provided a method for cleaning a membrane housing that further reduces the leaching of trace amounts of impurities.

### BRIEF DESCRIPTION OF THE DRAWINGS

FIG. 1 is a schematic cross-sectional view illustrating one embodiment (a membrane cartridge) of a membrane housing according to the present invention.

FIG. 2 is a schematic cross-sectional view illustrating one embodiment (a capsule filter) of a membrane housing according to the present invention.

FIG. 3 is a schematic diagram illustrating an example of the first cleaning step in the present invention.

FIG. 4 is a schematic diagram illustrating an example of the second cleaning step in the present invention.

FIG. 5 is a schematic diagram illustrating an example of the analysis step in the present invention.

### DESCRIPTION OF EMBODIMENTS

An embodiment of the present invention will be described in detail below. This embodiment is one example of the modes for carrying out the present invention, and the present invention is not limited to this embodiment.

The cleaning method of the present invention is a method for cleaning a membrane housing, through which a liquid to be treated, using a cleaning solution and ultrapure water.

Membrane housing refers to a housing in which a membrane is installed. The membrane may be installed directly in the housing, or stored in a cartridge (membrane cartridge) that is installed in the housing. Alternatively, a membrane and housing integrated into a single unit (capsule filter) may be used.

In the cleaning method of the present invention, cleaning of the membrane housing is usually performed on the membrane housing before liquid is passed through it. Cleaning of the membrane housing is usually performed with the membrane installed in the housing (membrane housing) (including the case of a capsule filter in which the membrane and housing are integrated). If the membrane housing is separable, cleaning may be performed with the membrane or membrane cartridge and the housing separated; however, when the membrane or membrane cartridge and the housing are separated and cleaned separately, it is preferable to also clean the membrane or membrane cartridge in a state in which it is installed in the housing. The following description relates to cleaning the membrane or membrane cartridge installed in the housing (including the case of a capsule filter), but is not limited thereto.

### <Membranes and Membrane Cartridges>

The membrane to be cleaned in the present invention is not limited by its usage condition, and may be either a new and unused or previously used, as long as it has the function of allowing the liquid to be treated to pass through.

There are also no particular limitations on the material of the membrane, and examples include polyethylene such as high-density polyethylene (HDPE), as well as cellulose, cellulose acetate, polysulfone, polypropylene, polyester, polyethersulfone, polyvinylidene fluoride, nylon, and the like. From a functional perspective, examples include ion adsorption membranes, particle removal membranes, and the like.

An ion adsorption membrane may be any membrane that has the function of adsorbing metal ions through an ion exchange reaction, or the function of removing metal ions and fine particles through electrostatic interaction. Examples include cation adsorption membranes having, as functional groups, strongly acidic ion exchange groups such as sulfonic acid groups, and cation adsorption membranes having, as functional groups, weakly acidic ion exchange groups such as carboxyl groups. In addition, anion adsorption membranes with strongly or weakly basic anion exchange groups, and chelate adsorption membranes with chelate exchange groups, may also be used.

Particle removal membranes are any membranes that have the ability to trap particulates through their pores. Examples include ultrafiltration (UF) membranes, microfiltration (MF) membranes, nanofiltration (NF) membranes, and reverse osmosis (RO) membranes. The membranes listed as particle removal membranes may also have ion exchange capability. In the present invention, membranes with ion exchange capability are referred to as ion exchange membranes, while those without ion exchange capability are referred to as particle removal membranes.

The membrane may be configured in the form of a cartridge, with the membrane housed in its own case.

### <Housing>

Examples of materials used for the housing include HDPE (high-density polyethylene), PVDF (polyvinylidene fluoride), PTFE (polytetrafluoroethylene), PFA (perfluoroalkoxyalkane), FEP (tetrafluoroethylene-hexafluoropropylene copolymer resin), PCTFE (trifluorochloroethylene), and ETFE (tetrafluoroethylene-ethylene copolymer resin). Preferred materials for the lining layer for use on the inner wall of the housing and for the sealing materials (such as O-rings) for use at the joints also include PVDF, PTFE, PFA, FEP, PCTFE, and ETFE.

There are no particular restrictions on the shape, volume, and the like of the housing, as long as the housing includes an inlet through which the liquid to be treated is introduced and an outlet through which the treated liquid is discharged.

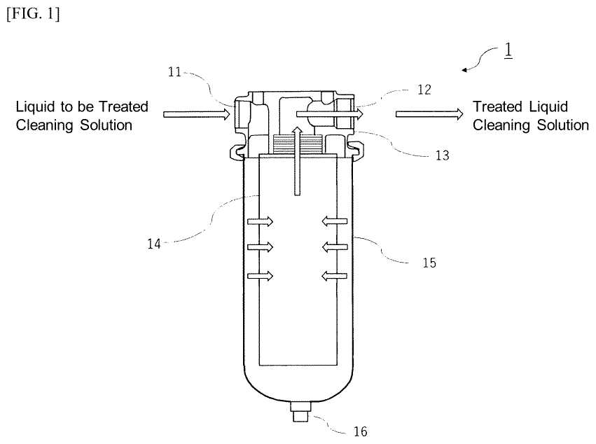

Below, the configuration of a membrane housing in which a membrane cartridge is installed inside the housing will be specifically explained with reference to FIG. 1.

FIG. 1 is a schematic cross-sectional view illustrating one embodiment of a membrane housing with a membrane cartridge installed. In the membrane housing 1 (using a membrane cartridge), a cartridge (membrane cartridge) 14 containing a membrane (not shown) is installed within a container formed by a housing head 13 and a housing bowl 15. The housing head 13 is removably secured to the housing bowl 15 via an O-ring (not shown). When replacing the cartridge, the cartridge 14 can be attached and detached by separating the housing head 13 and the housing bowl 15. A drain 16 is provided at the bottom of the housing bowl 15 for discharging liquids such as treated liquid.

The housing head 13 is provided with an inlet 11 for the liquid to be treated and an outlet 12 for the treated liquid. When carrying out the cleaning method of the present invention, cleaning solution or ultrapure water is introduced through the inlet 11, and these liquids follow the path indicated by the arrows in the figure and are discharged from the outlet 12. Examples of housing for mounting a membrane cartridge include the Chemlock PFA housing from Entegris and the Megaplast from Pall.

Next, the configuration of a membrane housing (capsule filter) in which the membrane and housing are integrated will be specifically explained with reference to FIG. 2.

FIG. 2 is a schematic cross-sectional view illustrating a capsule filter, which is one type of membrane housing in which the membrane and housing are integrated. The membrane housing 1 (capsule filter) includes a membrane element 20 fixed inside a housing 22. The membrane element 20 is composed of an upper surface member 25, a bottom surface member 26, an inner core material 23, an outer core material 24, and a membrane material 21. A specific example of the membrane material 21 is one formed from a pleated filtration material.

The top and bottom of the housing are respectively provided with an outlet 12 for the treated liquid and an inlet 11 for the liquid to be treated. When carrying out the cleaning method of the present invention, cleaning solution or ultrapure water is introduced through the inlet 11, and these liquids follow the path indicated by the arrows in the figure and are discharged from the outlet 12. Examples of housings include the Novacon and Iongard series from Cobetter, the Protego series from Entegris, and the IonKleen series from Pall.

Below, each step of the cleaning method of the present invention will be specifically explained with reference to the drawings.

### <First Cleaning Step>

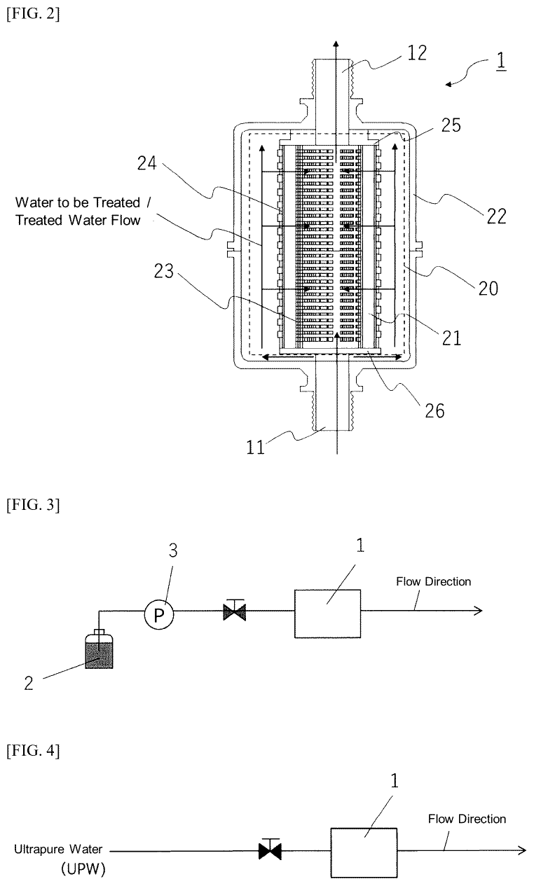

FIG. 3 is a schematic diagram illustrating an example of the first cleaning step. As shown in FIG. 3, in the first cleaning step, before the liquid to be treated is introduced into the membrane housing 1, the cleaning solution 2 is introduced to bring the inside of the membrane housing 1 into contact with the cleaning solution 2. The cleaning solution 2 may be either an acidic solution or a basic solution as long as the metal concentration (concentration of each element) is 100 ng/L or less. The metal concentration (concentration of each element) of the cleaning solution 2 referred herein indicates the concentration of each metal element contained in the cleaning solution 2 introduced into the membrane housing 1. Examples of the acidic solution include inorganic acid solutions such as nitric acid, hydrochloric acid, and sulfuric acid. Examples of the basic solution include sodium hydroxide solution, ammonia solution, and tetramethylammonium hydroxide solution. Examples of solvents for preparing these solutions include water such as pure water (resistivity: approximately 10 MQ·cm) and ultrapure water (resistivity: approximately 18 MQ·cm). However, ultrapure water is preferably used from the viewpoint of preventing contamination due to cleaning.

In a preferred example, the cleaning solution 2 is passed through the membrane housing 1 using a liquid delivery means 3 such as a chemical injection pump or nitrogen pressure delivery until the membrane housing 1 is filled with the cleaning solution 2. Once the membrane housing 1 is filled with the cleaning solution, the liquid delivery is stopped and the membrane housing 1 is immersed in the cleaning solution 2 for at least one hour to allow contact. There is no particular upper limit to the contact time, but it is preferably 24 hours or less. There is also no particular limit to the temperature of the cleaning solution 2, but the step is typically carried out at room temperature (e.g., 15 to 30° C.).

Representative examples of metals contained in the cleaning solution 2 include aluminum (Al), nickel (Ni), iron (Fe), and the like, as well as ions of these metals.

In the present invention, the metal concentration (concentration of each element) in the cleaning solution 2 may be 100 ng/L or less, preferably 50 ng/L or less, and more preferably 10 ng/L or less.

The acid and alkali concentrations of the cleaning solution 2 are, for example, 0.1% by mass or more, preferably 0.2% by mass or more, more preferably 2% by mass or more, and even more preferably 3% by mass or more. There is no particular upper limit to the acid and alkali concentrations; however, if the acid and alkali concentrations are high, it may take time to rinse out the acid and alkali (second cleaning step). If the acid and alkali concentrations of the cleaning solution 2 are less than 0.1% by mass, the cleaning effect may be reduced.

### <Cleaning Solution Preparation Container>

Examples of containers for preparing cleaning solution 2 include containers made of materials such as HDPE (high density polyethylene), PVDF (polyvinylidene fluoride), PTFE (polytetrafluoroethylene), PFA (perfluoroalkoxyalkane), FEP (tetrafluoroethylene-hexafluoropropylene copolymer resin), PCTFE (trifluorochloroethylene), and ETFE (tetrafluoroethylene-ethylene copolymer resin), and there are no particular restrictions on the shape, volume, and the like of the container.

### <Second Cleaning Step>

FIG. 4 is a schematic diagram illustrating an example of the second cleaning step. As shown in FIG. 4, in the cleaning method of the present invention, after completion of the above-described first cleaning step, ultrapure water (UPW) is passed through the membrane housing 1 to bring the inside of the membrane housing 1 into contact with the ultrapure water. This second cleaning step can enhance the cleaning effect of the membrane housing 1. It is preferable to pass the ultrapure water through the membrane housing 1 at a linear velocity (LV) of 0.1 to 2 m/h for 1 to 24 hours. The temperature of the ultrapure water to be passed is not particularly limited, but the treatment is typically carried out within the range of room temperature (e.g., 15 to 30° C.). The ultrapure water used for cleaning preferably has a metal concentration (concentration of each element) of 0.1 ng/L or less, more preferably 0.05 ng/L or less. The metal concentration (concentration of each element) of the ultrapure water referred to herein indicates the concentration of each metal element contained in the ultrapure water introduced into the membrane housing 1.

### <Pre-Cleaning Step>

In the cleaning method of the present invention, in order to further enhance the cleaning effect of the membrane housing 1, a cleaning treatment using ultrapure water (pre-cleaning treatment) may be performed on the membrane housing 1 in a step prior to the first cleaning step.

The conditions for this cleaning treatment are not particularly limited, but ultrapure water can be passed through the membrane housing 1 at an LV of 0.1 to 2 m/h for at least 1 hour. The temperature of the ultrapure water to be passed is not particularly limited, but the treatment is typically carried out within the range of room temperature (e.g., 15 to 30° C.). As in the second cleaning treatment step, the ultrapure water used for cleaning preferably has a metal concentration (concentration of each element) of 0.1 ng/L or less, and more preferably 0.05 ng/L or less. The metal concentration (concentration of each element) of the ultrapure water referred to herein indicates the concentration of each metal element contained in the ultrapure water introduced into the membrane housing 1.

### <Analysis Step>

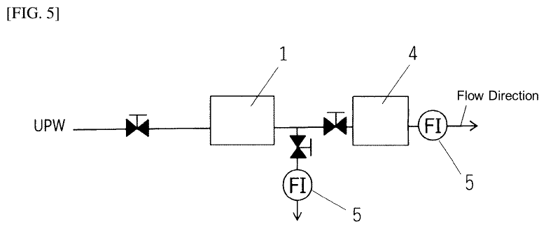

FIG. 5 is a schematic diagram illustrating an example of the analysis step. As shown in FIG. 5, in the cleaning method of the present invention, the analysis step is performed as a means for verifying whether the cleaning treatment is sufficient. The analysis step is performed during the second cleaning step or after completion of the second cleaning step. When the analysis step is performed during the second cleaning step, the metal concentration in the ultrapure water discharged from the membrane housing 1 after coming into contact with the inside of the membrane housing 1 is measured. When the analysis step is performed after completion of the second cleaning step, ultrapure water is passed through the membrane housing 1 again, and the metal concentration in the ultrapure water discharged from the membrane housing 1 after coming into contact with the inside of the membrane housing 1 is measured. In the analysis step, during the second cleaning step or after completion of the second cleaning step, ultrapure water is passed through the membrane housing 1 at a typical LV of 0.1 to 2 m/h, the ultrapure water discharged from the membrane housing 1 is concentrated by a concentrating means 4, and the metal concentration in the concentrated sample is measured. Alternatively, the sample to be measured may be directly collected from the ultrapure water discharged from the membrane housing 1 without being concentrated.

If the optimum flow rate for the membrane housing 1 differs from the optimum flow rate for the concentrating means 4, a valve is installed between the membrane housing 1 and the concentrating means 4 to appropriately adjust the flow rate. The flow rate to the membrane housing 1 is measured using a flow meter 5 located between the membrane housing 1 and the concentrating means 4, and another flow meter 5 on the concentrating means 4 side; and the flow rate to the concentrating means 4 is measured and adjusted using the flow meter on the concentrating means 4 side.

Examples of the concentrating means 4 include a heat concentration method in which the sample water is heated to concentrate it, and an ion exchange concentration method in which metals in the sample water are captured by an adsorbent, such as an ion exchanger, and the captured metals are eluted using an eluent such as an acid; and among these, the ion exchange concentration method is preferred because it reduces the risk of contamination during concentration. In particular, when a monolithic organic porous material is used, the differential pressure applied to the ion exchanger is low, and water can be passed through the ion exchanger in a short time; and therefore, it is preferable to adopt a concentration analysis using a monolithic organic porous material.

The method of analyzing the samples involves measuring the metal concentration (concentration of each element) in the sample water or eluent using a metal concentration measuring device, such as an inductively coupled plasma mass spectrometer (ICP-MS). As used herein, the metal concentration (concentration of each element) in the sample water or eluent refers to the concentration of each metal element contained in the sample water or eluent (i.e. the concentration of each metal element eluted from the membrane housing after cleaning).

It is preferable that the concentrations of metals (at least one of Li, B, Na, Mg, Al, K, Ca, Ti, V, Cr, Mn, Fe, Co, Ni, Cu, Zn, Ga, As, Sr, Mo, Pd, Ag, Cd, Sn, Ba, W, and Pb) eluted from the membrane housing 1 during or after the second cleaning step be 1 ng/L or less, and the lower the concentration, the better; it may be 0.1 ng/L or less, or even 0.01 ng/L or less.

The ion exchanger used for the analysis of metal concentrations may be exemplified by a non-particulate organic porous ion exchanger comprising a continuous skeleton phase and a continuous pore phase, wherein the thickness of the continuous skeleton is in the range of 1 to 100 μm, the average diameter of the continuous pores is in the range of 1 to 1000 μm, the total pore volume is in the range of 0.5 to 50 mL/g, the ion exchange capacity per weight in a dry state is in the range of 1 to 9 mg equivalents/g, and the ion exchange groups is distributed within the organic porous ion exchanger.

The cleaning method of the present invention includes a step of determining whether re-cleaning is necessary based on the analysis results obtained in the analysis step. Re-cleaning is required when the analysis results obtained in the analysis step confirm that metals have been discharged at concentrations equal to or higher than a target concentration, and it is determined that the cleaning treatment is insufficient. Preferably, re-cleaning is performed when the concentration of a metal (at least one of Li, B, Na, Mg, Al, K, Ca, Ti, V, Cr, Mn, Fe, Co, Ni, Cu, Zn, Ga, As, Sr, Mo, Pd, Ag, Cd, Sn, Ba, W, and Pb) in the ultrapure water discharged from the housing 1 exceeds 1 ng/L, as determined in the analysis step. The re-cleaning is carried out by repeating the second cleaning step, or by repeating both the first and second cleaning steps, and in each iteration (during or after the second cleaning step), the metal concentration is measured by means of the analysis step described above, and re-cleaning is continued until the metal concentration is reduced to the target level or lower.

A membrane housing cleaned by the cleaning method of the present invention exhibits further reduced elution of trace amounts of metals, and by applying this to, for example, the terminal sage of small- or medium-sized ultrapure water production equipment or of an ultrapure water production system, it becomes possible to produce high-quality ultrapure water. The term “small-sized ultrapure water production equipment” refers to, for example, ultrapure water production equipment having a flow rate of 2 L/min or less, which is used for analytical purposes and the like in research institutions and similar facilities. The term “medium-sized ultrapure water production equipment” refers to, for example, ultrapure water production equipment having a flow rate of 1000 to 3000 m³/h, which is used for cleaning electronic components and the like. The term “ultrapure water production system” refers to, for example, an ultrapure water production system having a flow rate of approximately 1000 to 10,000 m³/h, which is used in semiconductor manufacturing plants and the like.

The foregoing description provides application examples of the cleaning method of the present invention as applied to membrane housings; however, the cleaning method of the present invention can also be applied to cases in which only the membrane (membrane cartridge) is cleaned prior to being installed in the housing.

Exemplary embodiments [1] to [8] below illustrate examples of preferred embodiments in which the cleaning method of the present invention is applied only to the membrane (membrane cartridge) before it is installed in the membrane housing. In these exemplary embodiments, the descriptions concerning the membrane housing in the foregoing may be applied as appropriate.

[1] A method for cleaning a membrane (membrane cartridge) used in a membrane housing having an inlet for introducing a liquid to be treated and an outlet for discharging the treated liquid, wherein the liquid to be treated introduced from the inlet is treated and the treated liquid is discharged from the outlet,
the method comprising:
a first cleaning step of bringing a cleaning solution having a metal concentration (concentration of each element) of 100 ng/L or less into contact with the membrane (membrane cartridge);
a second cleaning step, performed after completion of the first cleaning step, of passing ultrapure water through the membrane (membrane cartridge), thereby bringing the membrane (membrane cartridge) into contact with the ultrapure water;
an analysis step, performed during or after completion of the second cleaning step, of
analyzing the metal concentration in the ultrapure water that has come into contact with the interior of the membrane (membrane cartridge) and has been discharged during the second cleaning step, or
analyzing the metal concentration in the ultrapure water that has come into contact with the membrane (membrane cartridge) and has been discharged from the membrane (membrane cartridge) after completion of the second cleaning step, by passing ultrapure water through the membrane (membrane cartridge) again; and
a step of determining, based on the results obtained in the analysis step, whether it is necessary to perform the second cleaning step again, or to perform both the first cleaning step and the second cleaning step again.

[2] The cleaning method according to [1], wherein, in the first cleaning step, the membrane (membrane cartridge) is maintained in a state in which the entire membrane (membrane cartridge) is in contact with the cleaning solution, and the membrane (membrane cartridge) is kept immersed in the cleaning solution for 1 to 24 hours.

[3] The cleaning method according to [1], wherein, in the second cleaning step, the ultrapure water is passed through the membrane (membrane cartridge) at an LV of 0.1 to 2 m/h for 1 to 24 hours.

[4] The cleaning method according to [1], wherein, in the analysis step, if the concentration of a metal (at least one metal selected from the group consisting of Li, B, Na, Mg, Al, K, Ca, Ti, V, Cr, Mn, Fe, Co, Ni, Cu, Zn, Ga, As, Sr, Mo, Pd, Ag, Cd, Sn, Ba, W, and Pb) in the ultrapure water after coming into contact with the membrane (membrane cartridge) exceeds 1 ng/L, the second cleaning step, or both the first cleaning step and the second cleaning step, are performed again.

[5] The cleaning method according to claim 1, wherein the membrane (membrane cartridge) is an ion adsorption membrane (membrane cartridge) or a particle removal membrane (membrane cartridge).

[6] The cleaning method according to [1], wherein the cleaning solution is an acid solution.

[7] The cleaning method according to [6], wherein the cleaning solution is a nitric acid solution.

[8] The cleaning method according to [1], further comprising a step of passing ultrapure water through the membrane (membrane cartridge) at an LV of 0.1 to 2 m/h for one hour or more prior to the first cleaning step.

### EXAMPLES

The present invention will be described in more detail below by way of examples, but the present invention is not limited to the following examples.

### Example 1: Cleaning Treatment for a Membrane Housing Equipped with an Ion Exchange Membrane (Article Subjected to Cleaning with Acidic Cleaning Solution and Ultrapure Water)

### <Membrane Housing for Evaluation (Integral Capsule Filter)>

As the membrane housing, an integral capsule filter in which a membrane and a housing are integrated was used.

This integrated capsule filter is composed of an ion exchange membrane having sulfonic acid groups as the ion exchange groups and polyethylene as the membrane base material, and a housing made of HDPE.

### <Cleaning Procedure>

Cleaning Treatment with Ultrapure Water (First Cycle)

The capsule filter equipped with the ion exchange membrane was subjected to a cleaning treatment using ultrapure water. The ultrapure water used had a metal concentration (concentration of each element) of 0.05 ng/L or less.

The cleaning treatment was carried out by passing ultrapure water through the capsule filter equipped with the ion exchange membrane at an LV of 0.6 m/h for 2,500 hours.

Cleaning Treatment with Acidic Cleaning Solution

A nitric acid solution having a metal concentration (concentration of each element) of 20 ng/L or less and a concentration of 3% by weight was prepared using high-purity nitric acid having a metal concentration (concentration of each element) of 100 ng/L or less and ultrapure water having a metal concentration (concentration of each element) of 0.05 ng/L or less. A housing made of fluororesin, which does not leach metals, was used in the preparation.

The capsule filter equipped with the ion exchange membrane, after being subjected to the above-described cleaning treatment with ultrapure water, was acid-treated by sealing the prepared acidic solution in it and allowing it to remain in contact with the solution for 18 hours.

Cleaning Treatment with Ultrapure Water after Acid Treatment (2nd Cycle)

The capsule filter equipped with the ion exchange membrane after the acid treatment was cleaned by passing ultrapure water, having a metal concentration (concentration of each element) of 0.05 ng/L or less, through the capsule filter equipped with the ion exchange membrane at an LV of 0.6 m/h for 24 hours.

### Analysis of Metal Concentrations in Effluent During Cleaning Treatment

Ultrapure water was passed through the capsule filter equipped with the ion exchange membrane in the second cleaning step at an LV of 0.45 m/h for 24 hours, and then the metal concentrations in the effluent were measured for the metal species shown in Table 1 by concentrating the effluent using a monolithic organic porous material and eluting the metals using a nitric acid solution as an eluent, and the metal concentrations in the resulting eluent were measured using ICP-MS (Agilent Technologies, 8900). In the analysis of metal concentrations using ICP-MS, a calibration curve relating count values (CPS) to metal concentrations was previously prepared using standard samples with multiple known metal concentrations, and the test sample (test water or treated water) was then measured, and the metal concentration corresponding to the count value was determined based on the calibration curve and taken as the metal concentration of the test water or treated water.

### Example 2: Cleaning Treatment for a Membrane Housing Equipped with a Particle Removal Membrane (Article Subjected to Cleaning with Acidic Cleaning Solution and Ultrapure Water)

### <Membrane Housing for Evaluation (Integral Capsule Filter)>

As the membrane housing, an integral capsule filter in which a membrane and a housing are integrated was used.

This capsule filter is composed of a particle removal membrane that does not have ion exchange groups and has polyethersulfone as the membrane base material, and a housing made of HDPE.

### <Cleaning Procedure>

The capsule filter equipped with the particle removal membrane was cleaned in the same manner as in Example 1, except that the cleaning treatment (first cycle) with ultrapure water in the <Cleaning Procedure> of Example 1 was replaced with a cleaning treatment in which ultrapure water having a metal concentration (concentration of each element) of 0.05 ng/L or less was passed through the capsule filter equipped with the particle removal membrane at an LV of 0.6 m/h for 340 hours, and the metal concentration in the effluent during the second cleaning step was measured.

### Comparative Example 1: Article Subjected to Ultrapure Water Cleaning Only

A capsule filter equipped with the same ion exchange membrane as in Example 1 was subjected to the ultrapure water cleaning treatment described in the <Cleaning Procedure> of Example 1, during which ultrapure water having a metal concentration (concentration of each element) of 0.05 ng/L or less was passed through the housing equipped with the ion exchange membrane at a LV of 0.45 m/h for 24 hours. The metal concentration in the effluent was measured in the same manner as in Example 1.

### Comparative Example 2: Article Subjected to Ultrapure Water Cleaning Only

Ultrapure water having a metal concentration (concentration of each element) of 0.05 ng/L or less was passed through a capsule filter equipped with the same particle removal membrane as in Example 2 at an LV of 0.6 m/h for 340 hours, and then ultrapure water having a metal concentration (concentration of each element) of 0.05 ng/L or less was passed through the capsule filter equipped with the particle removal membrane at an LV of 0.45 m/h for 24 hours. The metal concentration in the effluent was measured in the same manner as in Example 1.

The analytical results of the above-described Examples 1 and 2 and Comparative Examples 1 and 2 are shown in Table 1.

TABLE 1
(ng/L)

| Evaluated | | | | |
|---|---|---|---|---|
| Membrane | Ion Exchange Membrane | | Particle Removal Membrane | |
| Metal | | Comparative | | Comparative |
| Species | Example 1 | Example 1 | Example 2 | Example 2 |
| Na | <0.005 | 0.025 | <0.005 | <0.005 |
| Mg | <0.005 | <0.005 | <0.005 | <0.005 |
| Al | <0.005 | <0.005 | <0.005 | 0.006 |
| K | <0.005 | <0.005 | <0.005 | <0.005 |
| Ca | <0.005 | <0.005 | <0.005 | 0.029 |
| Cr | <0.005 | <0.005 | <0.005 | <0.005 |
| Fe | <0.005 | <0.005 | <0.005 | <0.005 |
| Cu | <0.005 | <0.005 | <0.005 | <0.005 |
| Zn | <0.005 | <0.005 | <0.005 | <0.005 |
| Pd | <0.005 | <0.005 | <0.005 | <0.005 |

As shown in Table 1, in the capsule filter equipped with the ion exchange membrane, sodium was insufficiently removed from the article cleaned only with ultrapure water (Comparative Example 1). In contrast, sodium was sufficiently removed from the article cleaned with the acidic solution and ultrapure water (Example 1), with the amount of sodium eluted being below 0.005 ng/L, which is the lower limit of quantification.

Furthermore, in the capsule filter equipped with the particle removal membrane, Al and Ca were insufficiently removed from the article cleaned only with ultrapure water (Comparative Example 2). In contrast, Al and Ca were sufficiently removed from the article cleaned with the acidic solution and ultrapure water (Example 2), with the amounts of Al and Ca eluted being below 0.005 ng/L, which is the lower limit of quantification.

From the above, it has been demonstrated that the cleaning method using the acidic solution according to the present invention is effective.

The present invention has been described above with reference to exemplary embodiments; however, the present invention is not limited to the above embodiments. Various modifications, which can be made by those skilled in the art, may be applied to the configurations and details of the present invention within the scope of the present invention.

This application claims priority to Japanese Patent Application No. 2023-060870, filed on Apr. 4, 2023, the entire disclosure of which is hereby incorporated by reference.

### REFERENCE SIGNS LIST

1 Membrane Housing
2 Cleaning Solution
3 Liquid Delivery Means
4 Concentrating Means
5 Flow Meter
11 Inlet
12 Outlet
13 Housing Head
14 Membrane Cartridge
15 Housing Bowl
16 Drain
20 Membrane Element
21 Membrane Material
22 Housing
23 Inner Core Material
24 Outer Core Material
25 Upper Surface Member
26 Bottom Surface Member

1. A method for cleaning a membrane housing having an inlet for introducing a liquid to be treated and an outlet for discharging the treated liquid, wherein the liquid to be treated introduced from the inlet is treated and the treated liquid is discharged from the outlet,
the method comprising:
a first cleaning introducing a cleaning solution having a metal concentration (concentration of each element) of 100 ng/L or less into the membrane housing, thereby bringing the interior of the membrane housing into contact with the cleaning solution;
a second cleaning, performed after completion of the first cleaning, of passing ultrapure water through the membrane housing, thereby bringing the interior of the membrane housing into contact with the ultrapure water;
an analysis, performed during or after completion of the second cleaning, of
analyzing the metal concentration in the ultrapure water that has come into contact with the interior of the membrane housing and has been discharged from the membrane housing during the second cleaning, or
analyzing the metal concentration in the ultrapure water that has come into contact with the interior of the membrane housing and has been discharged from the membrane housing after completion of the second cleaning, by passing ultrapure water through the membrane housing again; and
determining, based on the results obtained during the analysis,
whether it is necessary to perform the second cleaning again, or to perform both the first cleaning and the second cleaning again.

2. The cleaning method according to claim 1, wherein, during the first cleaning, the interior of the membrane housing is filled with the cleaning solution, and the interior of the membrane housing is kept immersed in the cleaning solution for 1 to 24 hours.

3. The cleaning method according to claim 1, wherein, during the second cleaning, the ultrapure water is passed through the membrane housing at an LV of 0.1 to 2 m/h for 1 to 24 hours.

4. The cleaning method according to claim 1, wherein, during the analysis, if the concentration of a metal (at least one metal selected from the group consisting of Li, B, Na, Mg, Al, K, Ca, Ti, V, Cr, Mn, Fe, Co, Ni, Cu, Zn, Ga, As, Sr, Mo, Pd, Ag, Cd, Sn, Ba, W, and Pb) in the ultrapure water discharged from the membrane housing exceeds 1 ng/L, the second cleaning, or both the first cleaning and the second cleaning, are performed again.

5. The cleaning method according to claim 1, wherein a membrane provided in the membrane housing is an ion adsorption membrane or a particle removal membrane.

6. The cleaning method according to claim 1, wherein the cleaning solution is an acid solution.

7. The cleaning method according to claim 6, wherein the cleaning solution is a nitric acid solution.

8. The cleaning method according to claim 1, further comprising passing ultrapure water through the membrane housing at an LV of 0.1 to 2 m/h for one hour or more prior to the first cleaning.

9. A membrane housing comprising an inlet for introducing a liquid to be treated and an outlet for discharging the treated liquid, wherein, when the liquid to be treated is passed through the membrane housing, the treated water discharged from the membrane housing has a metal concentration (concentration of each element) of 0.01 ng/L or less.

10. An ultrapure water production apparatus comprising the membrane housing according to claim 9.
